(19) United States
(12) Patent Application Publication
(10) Pub. No.: US 2008/0059453 A1
(43) Pub. Date: Mar. 6, 2008

(54) SYSTEM AND METHOD FOR ENHANCING THE RESULT OF A QUERY

(76) Inventor: Raphael Laderman, San Francisco, CA (US)

Correspondence Address: KEVIN J. MACK, 242 CURTNER AVE SUITE N, PALO ALTO, CA, 94306, US

(21) Appl. No.: 11/842,951

(22) Filed: Aug. 22, 2007

Related U.S. Application Data
(60) Provisional application No. 60/841,047, filed on Aug. 29, 2006.

(51) Int. Cl. G06F 17/30

(52) U.S. Cl. 707/5; 707/E17.017

(57) ABSTRACT

A system and method for enhancing the result of a query is disclosed. In some embodiments, the system comprises a plurality of data sources, an interface configured to query the plurality of data sources, and logic coupled to the interface and configured to enhance the result of a query to the plurality of data sources based on feedback from at least one user of the system.

### CROSS REFERENCE TO RELATED APPLICATIONS

This application claims priority to U.S. Provisional Application Ser. No. 60/841,047 entitled “System and Method for Rating, Categorizing and Finding Content,” filed Aug. 29, 2006, and incorporated herein by reference.

### FIELD OF THE INVENTION

The invention relates generally to systems and methods for searching a data source, and more particularly, to enhancing the result of a query to a data source.

### BACKGROUND

Vast amounts of data are contained within structured and unstructured data repositories, such as relational databases, XML documents, flat files, full-text databases and other storage mechanisms. Since the amount of data in these repositories can be large, a user must typically perform searches through these data repositories to obtain useful information.

Keyword based searching and Boolean based searching are two prevalent techniques for searching through structured data sources. With keyword based searching, a user specifies one or more keywords, or search terms, that are then located in the data source and reported to the user. Boolean based searching allows a user to specify a search string using one or more Boolean search commands. Boolean based searching provides the user with more flexible and precision than keyword searching because the Boolean search commands provide meaningful relations between keywords.

Keyword and Boolean based searching, however, have several shortcomings. First, if the data source contains many types of data, results may be provided that contain the keyword but are not germane to the user's search. For example, a user may want to find a specific article related to a keyword, but is instead presented with a large set of news stories or press releases which contain the keyword but are not germane. Similarly, the user may be searching for objective information on a subject but is instead presented with many items of commercial content providing biased information. Second, if the data source contains content of varying quality, the low quality content may be presented in the results before or mixed in with the higher quality content, making the higher quality content hard to find within the results list. For example, if a user is searching a collection of medical information, information from reputable sources such as university hospitals may be mixed with or preceded by information from unreliable sources such as faith-healers or quack cures. Another example is a user searching a collection of digital recordings of live concerts. Some of the recordings may be of low quality, while others may be well recorded, and some performances of the same piece by the same artists may be better than others. A typical keyword-based search would produce a list of results in which the good recordings, bad recordings, good performances and bad performances are listed together, with no easy way to determine which is which. Finally, many users are not skilled in forming efficient search queries. For example, if a user creates a search string that is too broad, a very large number of results may be returned and the user will have to painstakingly navigate through the results to find desired information. Conversely, if the search string is too narrow, too few results will be returned and the user will miss relevant information. Thus, what is needed is a system and method for searching that enhances the result of the search by alleviating one or more of the aforementioned shortcomings.

### BRIEF SUMMARY

A system and method for enhancing the result of a query is disclosed. In some embodiments, the system comprises a plurality of data sources, an interface configured to query the plurality of data sources, and logic coupled to the interface and configured to enhance the result of a query to the plurality of data sources based on feedback from at least one user of the system. In accordance with other embodiments, the method comprises receiving information from a user describing the quality of search results, storing the information in a data repository, and improving future search results based on the information.

### BRIEF DESCRIPTION OF THE DRAWINGS

For a detailed description of exemplary embodiments of the invention, reference will now be made to the accompanying drawings in which:

FIG. 1 illustrates a system constructed in accordance with embodiments of the invention;

FIG. 2 depicts a framework configured in accordance with embodiments of the invention; and

FIG. 3 shows a flowchart describing an exemplary method of searching a data source in accordance with embodiments of the invention.

### NOTATION AND NOMENCLATURE

In the following discussion and in the claims, the terms “including” and “comprising” are used in an open-ended fashion, and thus should be interpreted to mean “including, but not limited to”. Also, the term “couple, “couples,” or “coupled” is intended to mean either an indirect or direct electrical or communicative connection. Thus, if a first device couples to a second device, that connection may be through a direct connection, or through an indirect connection via other devices and connections. In addition, the term “data source” should be interpreted to mean any source of data. For example, a database storing information created by two or more entities represents a plurality of data sources.

### DETAILED DESCRIPTION

In this disclosure, numerous specific details are set forth to provide a sufficient understanding of the present invention. Those skilled in the art, however, will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise.

The following discussion is also directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

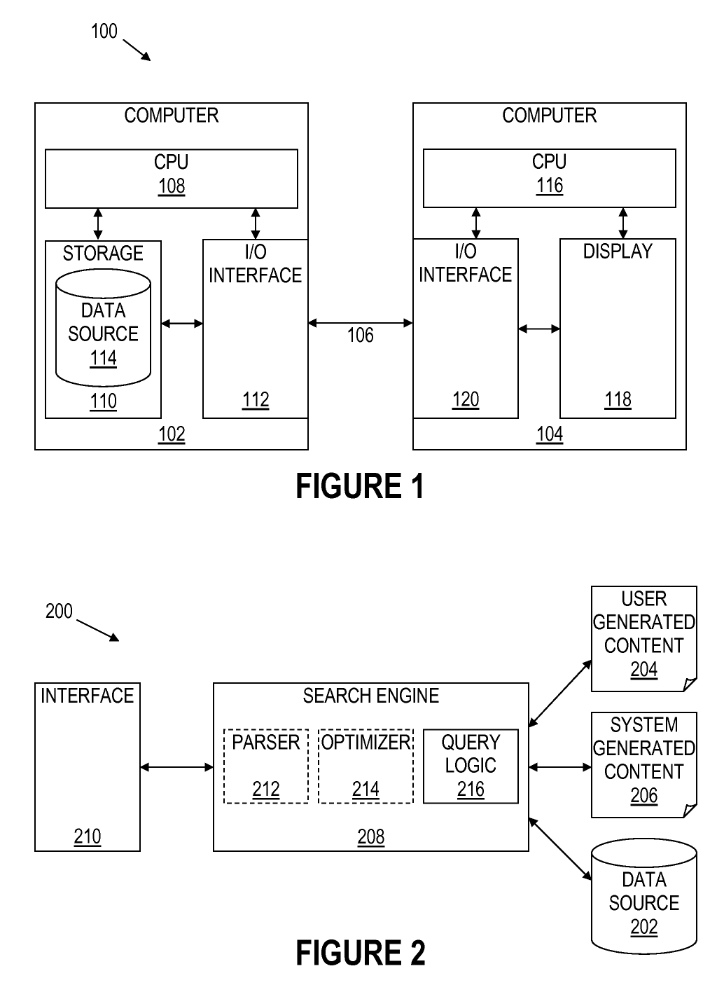

FIG. 1 illustrates a system 100 constructed in accordance with embodiments of the invention. System 100 comprises a plurality of computers 102 and 104 coupled together through a communications channel 106. The computers 102 and 104 may represent any type of computer system, such as a laptop computer, a personal computer, or a stand-alone computer operated as a server. The communications channel 106 may represent any type of computer network, such as the Internet, a local area network (LAN), and a wide area network (WAN), or any other type of communications link created through wire-line or wireless technologies, such as Bluetooth, Infrared, Ethernet, and Fiber Channel.

As illustrated in FIG. 1, the computer 102 comprises a central processing unit (CPU) 108, a storage 110, and an Input/Output (I/O) interface 112 coupled together. The storage 110 represents any type of volatile or non-volatile memory, such as random access memory (RAM) and read only memory (ROM), or any other medium for storing information, such as a hard drive, universal serial bus (USB) flash drive, memory stick, cell phone, and iPod®. The storage 110 comprises a data source 114. The data source 114 may represent a database, a flat-file, an XML file, or any other type of data repository, such as a partition on a DVD or CD-ROM. In addition, the data source 114 may represent a single physical unit that contains multiple sources of data. For example, the data source 114 may represent a database that contains information from a variety of sources, such as newspapers, magazines, and technical manuals. In some embodiments, the data source 114 may comprise a distributed data source with parts of the data source residing on a device associated with a user of the system 100.

The computer 104 comprises a CPU 116, a display 118, and an I/O interface 120 coupled together. The display 118 represents any device for portraying information, such as a monitor, television, and projector which portray visual information, or a speaker or headphone which portrays auditory information. Although not explicitly shown, the I/O interface 120 preferable comprises a data input device that represents any device for inputting information, such as a keyboard for inputting textual information, or a microphone for inputting auditory information, which may be transformed into textual information or utilized as auditory information by the computer 102. Generally, a user of the computer 104 may formulate a query for information stored in the data source 114 utilizing the data input device. This query may be transmitted to the computer 102, which may represent a database server. Although not explicitly shown in FIG. 2, the computer 102 may comprise logic designed to perform functions associated with data management, such as indexing of data, compression of data, and optimization of user queries. The computers 102 and 104 may comprise the single CPUs 108 and 116 respectively, or may comprise a plurality of CPUs arranged in a configuration where parallel computing may take place. Although only two computers and one data source are illustrated in FIG. 1, any number of computers and data sources may be used as desired.

FIG. 2 depicts a framework 200 configured in accordance with embodiments of the invention. As illustrated in FIG. 2, the framework 200 comprises a data source 202, a repository of user generated content 204, a repository of system generated content 206, a search engine 208, and an interface 210 coupled together. The search engine 208 comprises query logic 216 and optionally a parser 212 and an optimizer 214. The interface 210 may interact with the search engine 208 to query the data source 202. Thus, a user of the interface 210 may obtain information from the data source 202 by issuing a query to the search engine 208. The search engine 208 returns the results of the query to the interface 210 where the user may view them. Each component of the framework 200 may be implemented with one or more physical systems. For example, the interface 210 may reside on a physical computer system that is distinct from the physical computer system that implements the search engine 208. The interface 210 and the search engine 208 may communicate through a network, such as the Internet. Similarly, the data source 202 and the user and system generate content 204, 206 may reside on the same physical system or discrete individual systems as desired.

The search engine 208 preferably utilizes the user generated content 204, the system generated content 206, or a combination thereof when executing a user's query. The user generated content 204 comprises any type of information created by a user of the framework 200. In particular, the user generated content 204 may include user feedback related to individual data items in the data source 202, the results of a query to the data source 202, the users of the framework 200, or the feedback itself. For example, a user may rate a particular item of content contained within the result of a search query as highly relevant to the query. These rankings constitute user generated content, as do any user reviews of these rankings.

The system generated content 206 comprises any type of content that is automatically generated and associated with the user generated content 204 or a user of the framework 200. For example, an importance factor may be automatically generated and associated with each user. This importance factor may affect how significant a positive or negative rating of content by a particular user affects the content's placement in the results of a query. Ratings created by users with high importance factors may generally affect the results more than users with low importance factors. The importance factor may be generated by taking into account characteristics of the user, such as the number and quality of the ratings provided by a user, the length of time a particular user has been a member of the framework or any sub-part of the framework, and any other information indicative of the strength of a user's feedback, such as the user's profession, age, and educational level.

When a user queries the data source 202, the search engine 208 may report to the user any user and system generated content 204, 206 associated with the query and may also utilize the user and system generated content 204, 206 to prioritize, refine, filter, or otherwise modify the results of the query. For example, users of the framework 200 may consistently rank a particular piece of information stored in the data source 202 as highly relevant to a particular keyword or search string. When a user formulates a query using the same keyword or search string, the search engine 208 may report this user generated relevancy so that the user may efficiently identify which items of content are meaningful. In addition, the search engine 208 may utilize this user generated relevancy to prioritize results of the search by listing items of high user relevancy before those with low user relevancy. Although user generated relevancy was used in the preceding example, any type of user and system generated content associated with a user's query may be used as desired.

As can be appreciated, the system 100 and framework 200 provide a flexible and scalable means of querying data sources. Although only one data source, search engine, and interface are illustrated in FIG. 2, any number of data sources, search engines, and interfaces may be employed as desired. In addition, any type of interface may be employed, such as a graphical user interface (GUI), a command line interface, a virtual interface, an auditory interface, and a haptic interface.

In accordance with at least some embodiments, the data source 202 represents a database that is searchable through a multi-field inverted text index or a plurality of inverted text indexes. For non-textual content, such as audio, video, images and other non-textual content, metadata describing the non-textual content may also be stored in the database. The data and metadata may be entered into the data source 202 through one of a plurality of methods, including manual uploading or entry of data through web-based forms, file transfer protocol (FTP), Secure Shell (SSH) file transfer protocol, Really Simple Syndication (RSS), “spidering” of content by following links found within a content item to one or a plurality of other content items, or any other method of transferring data to a data source.

The system 100 and the framework 200 are preferably configured to perform a variety of search related functions and techniques. These search related techniques are preferably performed by the query logic 216 and may be implemented in software, hardware, or a combination thereof. Generally, the techniques either facilitate the querying of a data source or enhance the quality of the results associated with queries to a data source. These techniques including keyword searching; category or topic searching; category or topic browsing; non-textual searching; user ratings of searches; user ratings of content; other types of user feedback on content; user categorization of content; user keywording of content; user reviews of content; user ratings and feedback on user reviews of content; user ratings values; user favorites lists; multi-dimensional ratings of content; multi-dimensional ratings of users; time-based ratings; searches by topic or category; searches by keyword or search expression; searches limited to content of one or more content types; searches limited to content approved, endorsed or highly rated by one or more users; searches limited to content approved by one or more content providers; assisted searching and search refinement through search automation methods; and combinations or variations of the preceding techniques. Each of these techniques is discussed more fully below.

Keyword searching enables users to specify one or more keywords, or search terms, that are then located in the data source. In some embodiments, searches may be performed across some or all of a collection of data sources by means of keywords, key phrases, and other search terms. For textual data, such as documents, books, HTML, XML, and other primarily textual content, the content may be directly searched for the keywords. For non-textual data, such as images, video, audio and other primarily non-textual content, metadata, file names, transcripts, and other textual data associated with the data may be searched for the keywords.

Category or topic browsing enables users to broadly search through a data source by high-level categories. The data may be organized by one or more classifications including taxonomies, topic areas, interest areas and other groupings. In addition, users may browse through and search these groupings for content. Users may also perform searches on the categories themselves to find groupings that are of interest to the user.

Non-textual searching provides users with the ability to search with non-textual methods either separately or in addition to textual searches. These non-textual methods may include finding content similar to other content, for example finding video content similar to other video content; finding video content which contains audio content similar to other audio content; finding video content which contains images similar to other still images; or associating any other combination of media types which have a similarity in one or more attributes.

User ratings of searches allow users to provide feedback on the results of their searches. This feedback may include rating the overall search results, rating the accuracy of the results, or rating any other metric related to the quality of the results. In addition, user feedback may be used by the search engine to modify, enhance, or refine search results to be more in accordance with user expectations.

User ratings of content permit users to rate content returned by a search. In addition, user ratings of content may be utilized to influence the ordering of or appearance of content in the results of a search. For example, content of very low quality may be withheld from a user because it is unlikely to be relevant to the user's query. Similarly, content with a high user ranking may be displayed before content with a lower user ranking. User ratings of content from trusted sources may also be weighted more heavily than user ratings of content from non-trusted sources because the quality of content from trusted sources is presumed to be relatively high. Trusted sources may be classified by any means for validating the reliability or relevancy of the information contained in the source.

Other types of user feedback, including specific questions, may similarly be utilized to enhance the quality of a search. For example, a user may be prompted to answer one or more of the following questions after searching a data source. “How related is this content to your search?” A user may answer this question by allowing the user to pick from possible answers such as “Exactly related”, “Very related”, “Somewhat related”, “Not very related”, “Not related”; by a numerical scale, slider, or direct text entry; or by any other means of recording a user's response to the question. This response may be utilized to tune future search results, to associate or disassociate content from categories and keywords, to increase or decrease the content's place in results ordering for this and similar searches, or for any other purpose designed to enhance the quality of a search.

“If this content is not exactly related, what keywords or search terms would better describe it?” A user may answer this question through free-form entry of keywords or search terms, by allowing the user to select from a set of possible keywords, by allowing the user to browse through a taxonomy of categories to arrive at the correct place in the taxonomy for this content, or by any other means of recording a user's response to the question. The response may be utilized to associate or disassociate content from categories and keywords and for any other purposes designed to increase the quality of a search. In some embodiments, user responses to questions of this type may be used by the system to disambiguate automated categorization. For example, when several possible categories may apply to an item of content, the category with the highest user response may be used to classify the content. In other embodiments, the system may present one or more alternative categories to the user and allow the user to select one or more of these categories as applying to the content, either by marking them as applying or not applying, by means of a slider or rating denoting how well each category applies, by ordering the categories in order of applicability, or by any other means for recording a user's response.

“What type of content is this?” A user may answer this question by selecting one or more types of content from a list, by free form text entry, or through other means of recording a user's response to the question. Some of the many types of content which may be selected could include: “Corporate Information”, “Shopping”, “Advertising”, “Educational”, “Informational—Non News”, and “Current News”. Particularly where content is from non-trusted or unknown sources, it may be difficult to algorithmically determine the type of content. User input may therefore aid in such determinations. This information may then be used to automatically limit searches to a particular type or types of content, to allow users to similarly limit searches, to control ordering in results lists, and for other purposes designed to increase search quality.

“How time-oriented is this content?” A user may answer this question by picking from possible answers such as “Daily News”, “Weekly News”, “General Information: Not News-Related”; by a numerical scale, slider or direct text entry; or by any other means of recording a user's response to the question. This information may be used to automatically limit searches to one or more time-orientations of content, to allow users to similarly limit searches, to control ordering in results lists, or for other purposes designed to increase search quality.

“How fresh is this content?” A user may answer this question by selecting from a set of choices such as “Within the last hour”, “Today”, “This week”, “This month”, “Within the last 3 months”, “Within the last year”, inputting a numerical value, utilizing a slider, or any other means of recordings a user's response related to the question. This information may be used to automatically limit searches based on freshness of content, to allow users to similarly limit searches, to control ordering in results lists, or for any other purpose designed to increase search quality.

“What age-rating should be associated with this page?” A user may answer this question by selecting from a set of choices such as “G (suitable for all ages)”, “PG”, “R”, “NC-17”, “XXX (sexually oriented content for adults only)”, through a numerical value, a slider, or any other means for evaluating the age-rating of content. This information may be used to automatically limit searches to one or a plurality of age-ratings of content, to allow users to similarly limit searches, to control ordering in results lists, or for any other purpose designed to increase search quality.

“Is this valid content or SPAM content?” A user may respond to this question by selecting from a set of choices such as “Valid”, “SPAM”, or alternatively could be asked “How likely is the content SPAM?”, and answered through a numerical value, a slider, and any other means for recording a user's response to the question. This information may be used to automatically limit searches to one or a plurality of SPAM-ratings of content, to allow users to similarly limit searches, to control ordering in results lists, or for any other purpose designed to increase search quality.

“Is this content likely to be offensive to a particular racial or religious or social group?” A user may answer this question through a “Yes/No” response, a numerical value, a slider or any other means for recording a user's response to the question. It may also be answered either additionally or separately by allowing the user to select from a list of groups who might, in the judgment of the user, find the content offensive, or by allowing the user to enter the names of these group or groups, or through other means of designating classes of individuals.

User categorization of content allows users to group content under one or more topics areas. User categorization of content may be utilized either as a primary method of content categorization or as one of several methods which are utilized together or separately to determine which taxonomic category or categories are best suited to the content. As previously mentioned, this categorization may occur within the context of user feedback of content returned as the result of a search. User categorization may also take place in one or more other circumstances, for example, if users manually submit content to the system, or if users are asked by the system to or choose to review the categorization of content.

User keywording of content enables users to specify one or more keywords that are relevant to the content. Keywords may be used in addition to or instead of categorization. Generally, keywords are any words which can be used to find or filter content. Keywords become more useful when they accurately find or filter content. For example, the word “the” would not by itself usually be useful as a keyword because most English textual content contains the word “the.” Thus, this keyword would not usually allow specific content to be found or filtered. A specific set of keywords such as “NASA Apollo missions,” on the other hand, may find or filter a specific set of content associated with this topic.

Keywords may be associated with content in various ways. For example, a keyword may be associated with content if the keyword is contained within the content. Some embodiments of the invention include the capability of associating additional keywords with content even though those keywords are not found in the content. As previously mentioned, this keywording may occur when a user associates a keyword to content after a search. User keywording may also take place in one or more other circumstances, for example, when users manually submit content to the system, or if users are asked by the system to choose or review the keywording of content. Keywords may also be added to content automatically by the system through one or more means, which may include comparing documents to other already keyworded documents and applying keywords from documents which are calculated to be sufficiently similar, utilizing keyword equivalence lists which associate keywords or key phrases with other keywords or phrases, or any other means of automatically associating keywords to content.

User reviews of content enable users to create reviews of content in addition to or instead of ratings. These reviews may be textual, or may utilize other types of media such as audio, video or images. The reviews may be synopses, comments, opinions or any other types of reaction to the content. Users may be asked for different types of content reviews either as part of the user feedback process, when they submit content manually to the system, when they are asked by the system to or choose to review content, or in any other circumstance as desired. Users may also provide ratings and feedback on the user reviews of content. The user reviews and favorites lists are preferably treated as content in that they themselves may be rated, searched for, categorized, filtered, reviewed, and keyworded.

Users may also be assigned one or more user rating values. A user rating value may be explicitly shown to the user or may be hidden. User rating values are utilized as a weighting to determine the importance of the user's feedback. When a user with a high user ratings value provides feedback on a piece of content, their feedback is preferably given a higher weight or importance than feedback provided by a user with a low user ratings value. This weighting may then be used to calculate one or more content ratings for that piece of content. The effect is that users with a higher user rating value generally have more influence over the ratings of content than do users with a low user rating value. User ratings values may be assigned in a variety of ways, such as when a user provides feedback on or rates content or searches. If the feedback disagrees with the majority of or with some percentage of the other user feedback on the same content or searches, a lower user rating value may be assigned. User ratings may also be assigned when a user provides feedback on or rates content or searches. If the feedback agrees with the majority of or with some percentage of the other feedback, the act of providing feedback may also raise the user's rating value. If a user's reviews or favorites lists are given high or low ratings by other users, this may also raise or lower the user's rating value accordingly. If a user submits content to the system and this content is later given high or low ratings or receives positive or negative feedback, this may also raise or lower the user's rating value accordingly.

Users may also create lists of their favorite content, favorite searches, favorite categories, favorite keywords, favorite reviews, favorite users, or other favorite information. This generation of favorite information may be accomplished in a variety of ways, including manually adding sites to a favorites list, automatically adding sites that the user rates highly, allowing the user to upload web browser bookmarks lists, allowing the user to upload favorites lists in other formats such as XML formats, RSS, ATOM, or by other means of selecting content. As previously mentioned, in some embodiments these lists are treated as content in that users may rate, review, and provide feedback on the favorite information.

The system may also create multi-dimensional ratings of content. Single “monolithic” ratings of content may be very useful, but may also lose useful information. To provide useful ratings, it is beneficial to have a multi-level rating system so that content which is unpopular in general, yet highly rated by some group of people will still show up as highly rated at least for those people. For example, a given piece of content could be given a very high rating by some percentage of users and a very low rating by another percentage of users. If only the average rating were used, the content would receive an average rating overall, ignoring the fact that that certain users consider the content to be very good and others consider it to be very bad. In fact, there are often distinct groups of users who consider some content to be high quality and other distinct groups of users who consider the same content to be low quality. For example, all “punk” music is likely to be given a low rating by most users, but within the group of users who are fans of this genre, not only will the average rating of this type of music be higher, but certain bands and songs will also be rated higher. Another example involves political content. Those users whose political views are inline with views expressed in the content are more likely to rate it highly, while those whose with views in opposition are more likely to give the content a low rating. To address this issue, each item of content is preferably associated with two or more ratings—one overall rating and one or more additional ratings describing how the content is viewed by groups of people who are somehow related with that type or genre of content. These ratings may be created automatically using heuristics or manually through user selection of one or a plurality of sub-groups they wish to use in filtering and ordering the results of their searches.

The system preferably also permits multi-dimensional ratings of users. Single ratings of users can lose information just like single ratings of content. For example, if a user has an opinion which disagrees with the majority or with some other group of users, that user may be penalized for this opinion by receiving low user rating values. Some of these users who would otherwise have low overall user ratings values can be considered to be members of special interest groups which have opinions not in accordance with the majority, but are in accordance with others in that group. Various examples of such groups can be identified or created on the basis of ethnicity, religion, political beliefs, place of residence, place of birth, socioeconomic category, musical preferences, and any other basis for categorizing individuals. Depending on how groups are identified, a user may belong to one or more of the groups. Some embodiments of the invention form groups by overall similarity, as identified through their ratings and other user feedback, and may enable users to search for content which was highly rated by people within a particular group. In other embodiments, users are grouped by their profile. As can be appreciated, user profiles may contain a wealth of information that may enable grouping of users to be formed.

In some embodiments, groups are associated with categories in a taxonomy or with keywords. In these embodiments, users who consistently rate or provide feedback on content within a certain category or content which is associated with certain keywords may be placed by the system in a group of users who is interested in this type of content. In some embodiments with multi-dimensional user ratings, users may be assigned different user rating values in a plurality of groups, such that they could achieve high user rating values within some group or groups, but may have a lower user rating in other groups. In still other embodiments, the system may determine which sub-groups a user is most similar to, and automatically use this information to filter or order search results. Users may also examine automatic assignments and may manually override them. In yet other embodiments, users may manually assign themselves to groups by selecting one or more groups. In these embodiments, the assignments may be utilized to allow users to find other users with similar preferences.

One or more ratings types such as content ratings, user ratings, or other ratings may also be marked with a timestamp indicating when the rating was performed. In these embodiments, timestamps are used by the system in various ways. For example, old ratings may be considered less likely to be valid than newer ratings. If a user's rating value changes with time, the system may change the weightings used for all of the user's previous ratings and feedback, may change only the more recent ratings, or may change only future ratings.

In some embodiments, search results may be limited to content within one or a plurality of categories or topics. For example, searches may be limited to only informational content, only news content, only commercial content, content within a subject category, or in other ways. Other embodiments may not limit search results but will more prominently feature or otherwise highlight these results. In at least some embodiments, searches may be conducted using keywords and/or Boolean or other search expressions in addition to and/or instead of other search types. In still other embodiments, searches may be limited to content of one or more content types: The content types include text, images, video, audio, or any other type of content. Search results may also be limited to content which has been approved by, endorsed by, or highly rated by a particular user, a specific list of users or a group of users. Other embodiments may not limit search results, but will more prominently feature or otherwise highlight these results.

Searches may also be limited to one or more approved content providers: In these embodiments, search results are limited to content approved, endorsed, or highly rated by one or a plurality of content providers. In some cases, the endorsed, approved, or highly-rated content is provided by the content provider; in other cases, a list of approved, endorsed and/or highly rated content is provided. For example, if a user is searching for medical content, and if the American Medical Association has a list of approved, endorsed, or highly rated providers of medical content, some embodiments allow search results to be limited to content from these providers only. Other embodiments may not limit search results but will more prominently feature or otherwise highlight these results.

In some embodiments, the system also provides assisted searching and search refinement through search automation methods. For example, the system may attempt to interpret the user's query based on user input such as keywords or other user input. The system may then attempt to match this information with categories within a one or a plurality of taxonomies or other groupings of content. If this process is successful, one or more actions may be performed. These actions include conducting a search with results limited to content within the matched grouping or groupings and displaying the results of that search instead of or in addition to the results of the user's initial search; using the results of such searches to modify the order or ranking of results displayed to the user; listing one or a plurality of suggested searches within the matched grouping or groupings which the user may manually select that the system perform, or any other action design to assist the user.

In addition, the system may attempt to interpret the user's query based on the user's input such as keywords or other inputted information. The system may then match this information with other searches entered by other users, preferably utilizing one or more types of information, including previous user feedback from the current user or other users, the user's previous searching history, the user's feedback and ratings, or any other information that enables the system to identify alternate keywords, search terms or search phrases which may be useful in assisting the user's search. If this process is successful, one or more actions may be taken by the system. These actions include performing one or more searches using the keywords, search terms or search phrases which were identified by the system, and displaying the results of that search instead of or in addition to the general results of the user's initial search; using the results of the search to modify the order or ranking of results displayed to the user; listing the keywords, search terms or search phrases as one or more of suggested searches which the user may manually select, or other actions designed to assist the user.

In various embodiments, there is, in addition to one or a plurality of full-text indexes, one or a plurality of categories and subcategories which may be thought of as forming one or a plurality of taxonomies. When content is added to the search system manually or from known and trusted sources, the content may be readily classified and categorized. If the trusted source is known to be a source of news articles, for example, it may be possible to reliably classify the content as “News” content. If the trusted source is known to be a high-quality source, it may be possible to reliably classify the content as “Probably Good” content. Some sources may also provide reliable categorization information, allowing the content to be accurately placed within one or a plurality of categories within a taxonomy.

When content is acquired from unknown or untrusted sources, however, it is not possible in all cases to accurately determine whether the content is “News” content or “Advertising” content, or some other type of content. It is also not possible in all cases to determine if the content is high or low quality. Additionally, it may not be possible to accurately categorize the content so that it can be reliably placed within one or a plurality of categories within a taxonomy. In these case, content may be assigned to one or a plurality of categories through one or more methods including manual assignment by a user or editor, automated assignment on the basis of keywords in the content; automatic assignment on the basis of metadata associated with the content; automated assignment on the basis of links from or references contained in other content which refer to the content, and by other means for categorizing content.

In manual assignment by a user or editor, the content is manually assigned to the category by one or a plurality of users or editors. In some embodiments, there is a workflow or moderation process by which an assignment is first suggested by one or more users and must then be confirmed by one or more users before the assignment is confirmed, made permanent, shown generally to most users, or otherwise made public. In other embodiments, assignments may be nullified or deleted if other users disagree with the assignment and indicate this through voting or other user feedback. In some embodiments, assignments are not all-or-nothing, but have a strength or numerical value associated with them. In some of these embodiments, voting, confirmation or other user feedback can strengthen or weaken the assignment. In other embodiments, the strength of such a category assignment is used by the system in filtering, ordering or otherwise modifying search results.

With automated assignment on the basis of keywords, the system preferably performs analysis on the words found within text associated with the content and attempts to assign the content to one or a plurality of categories based on this analysis. This assignment may be performed by lexical analysis, unique keyword matching, word frequency analysis, Bayesian analysis, comparison with content already assigned to categories, and by any other methods of automated categorization. Some embodiments perform document analysis prior to performing textual analysis and may give a greater or lesser importance or weight to data depending on its position or type in the document. For example, some of these embodiments assign different weights to textual data found in document headings or subheadings while other embodiments ignore or give a lower weighting to data found in some sections of a document, for example in the case of web pages, navigational elements or advertisements may be ignored or assigned a lower weighting.

In automated assignment on the basis of metadata associated with the content, the system inspects metadata associated with the content and may utilize this information by direct assignment to one or a plurality of categories based on the metadata, provisional assignment to one or a plurality of categories based on the metadata; analysis of the metadata as text, or by any other means of processing textual data. One example of metadata associated with content is the ID3 or ID3v2 tag associated with MP3 audio content. Metadata contained within this tag may include the Artist, Year, Genre, codec and other information. This metadata could be used to assign the content to categories such as a category associated with the Artist, another category with content associated with the Year, another category with content associated with the genre, and a further category associated with the codec.

Metadata may be correct, partially correct or incorrect. In addition, metadata may be reliable, partially reliable or unreliable. The assignment of content to one or more categories based on metadata may therefore not be correct or reliable in all cases. Therefore, in some embodiments, assignments may be affected by user feedback. In these embodiments, user feedback on assignments is utilized to assign one or more reliability or correctness ratings to content providers and sources. High reliability ratings are assigned to content providers and sources that provide metadata which consistently results in “good” category assignments, that is metadata which results in category assignments which consistently receive approval via user feedback. In some embodiments, which utilize variable strength assignments, these reliability or correctness ratings are used to strengthen or weaken the assignment. In some of these embodiments, very unreliable sources or content providers would have metadata reliability or correctness ratings so low that their metadata would not be utilized in category assignment.

In at least some embodiments, user feedback may be utilized by the system in several ways, some of which have been listed previously, including modification, refining, filtering or ordering of search results, or in other ways. User feedback may be correct, incorrect, partially correct or deliberately incorrect. In order to make optimal use of user feedback, it is useful to be able to assign a reliability or correctness rating which can be utilized by the system in its calculations, such that less reliable or correct feedback is given a lower weight or priority.

User feedback ratings are preferably assigned when a plurality of feedback from the same user is analyzed. One way to associate feedback with a particular user is through a log-in or other authentication method which validates that a particular user has produced a particular feedback. Therefore, some embodiments allow users to create accounts and to log into these accounts via authentication, such as a secret password or other authentication means. User log-in validation or authentication may not be available for some users, either because they have not logged in, have not created an account, or for other reasons. In these cases, alternative methods of identification may be used. One such alternative method is cookie-based identification, which uses a uniquely identifiable value which is stored on the user's computer and which can be retrieved by the system when the user interacts with the system by means of a web browser such as Internet Explorer, Firefox, and Safari. This method may identify users, but may not be as accurate or reliable as user log-in or authentication for several reasons, including the possibility that a plurality of users may use the same computer. Another method is IP address identification. This method may suffer from some of same issues affecting cookie-based identification, however it has the additional issue that multiple computers may utilize the same IP address. Some embodiments which utilize these and other user identification methods assign a confidence rating to the type of method utilized for each user feedback and use this rating in calculations assigning a weight or priority to the feedback. In some of these embodiments, the reliability of a particular user over time is also taken into account and may fully or partially override such confidence ratings.

Some embodiments expose different functionality to authenticated and non-authenticated users. For example, some functions may be limited to authenticated users, such as the ability to review content, to provide detailed feedback on content, to rate content, to rate users, to join groups, to view certain kinds of content, or other functions.

When a user accesses search results, the system optimally provides an easy method to allow the user provide feedback on the content. If the content is being viewed using a web browser, an area of the screen may be utilized to query the user for feedback. This area may be implemented as a frame, a floating panel, a window, a sidebar or in other ways. Alternatively, a separate web browser window, frame, panel, sidebar; a separate dedicated application; a plug-in for other applications or other means may be used to obtain user feedback.

Search restrictions may also be utilized to enhance the user's experience. Search restrictions allow results to be limited to particular types of content or to exclude particular types of content. For example, searches may be able to include or exclude commercial content such as shopping sites; spam content which does not contain the information expected, or which contains other information that is not germane; informational content; news content, or other content. Identification of content types, in a preferred embodiment, may be accomplished through several means, which may include identifying content types through user feedback; identifying content types based on source or website types identified through user feedback; identifying content types based on programmatic or algorithmic analysis; identifying content types based on source or website types identified through other means; identification of content types through manual or automatic categorization; or other means of identification of content types.

Various user modifiable search options are also preferably employed. An example of some user modifiable search options include searching only brand name content (i.e., content from a set of widely known or highly rated content providers), searching only highly rated content; searching only content which was highly rated by certain specified subgroups of users, searching only content which is new or of a certain age searching only content from a specified list of sources, and searching only content that the user has not previously viewed or downloaded.

The preceding discussed various techniques for searching through a data source or enhancing the result of the query to a data source. Numerous variations and modifications will become apparent to those skilled in the art once the above disclosure is fully appreciated. The techniques described may be performed in isolation, or in conjunction with, other disclosed techniques as desired.

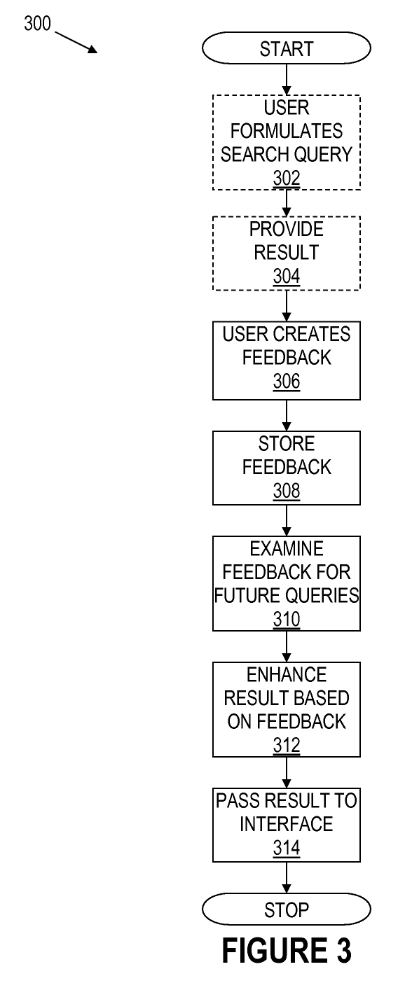

FIG. 3 illustrates an exemplary method of searching a data source in accordance with embodiments of the invention. The method 300 starts when a user optionally formulates a search query (302). As previously discussed, the user preferably formulates the query through a user interface. The search query is then optionally applied to the data source and the result of the query is provided to the user (304). The user may then create feedback describing the quality of the result or any other aspect of the system (306). As previously discussed, this feedback may comprise a rating, ranking, and review of the results, or any other type of user generated information describing the result, portion of the result, or any content of the system. The feedback is then stored so that it may be subsequently accessed (308). When another user query is formulated, the feedback is examined (310) and the result of this query is enhanced based on the feedback, if feedback exists that relates to the query (312). The process stops after the enhanced results are passed to the interface where the user may perceive them (314). Steps may be added, removed, or reordered as desired. For example, the feedback may be reported directly to the user so that the user may quickly identify the quality of the results. This reporting may occurred in conjunction with, or in place of, enhancing the results. As previously discussed, the interface may comprise a graphical user interface, a command line interface, a virtual interface, an auditory interface, a haptic interface, or any other type of interface that enables a user to perceive the results.

The above discussion is meant to be illustrative of the principles and various embodiments of the present invention. Numerous variations and modifications will become apparent to those skilled in the art once the above disclosure is fully appreciated. For example, in embodiments utilizing the Internet, the system may automatically ascertain a user's location through the user's Internet Protocol (IP) address. Once the user's location is ascertained, the user may automatically be associated with other users in physical proximity. This association may further enhance various techniques described herein, such as the multi-dimensional ratings of content and users. In particular, because users located in physical proximity are likely to have similar preferences, feedback from users located in a particular geographic area may be weighted more heavily than feedback from users in noncontiguous or remote regions. It is intended that the following claims be interpreted to embrace all such variations and modifications.

What is claimed is:

1. A system, comprising:
a plurality of data sources;
an interface configured to query the plurality of data sources; and
logic coupled to the interface and configured to enhance the result of a query to the plurality of data sources based on feedback from at least one user of the system.

2. The system of claim 1 wherein the feedback comprises an evaluation of the relevancy of the result.

3. The system of claim 1 wherein the user interface is selected from the group consisting of a graphical user interface, a command line interface, a virtual interface, an auditory interface, and a haptic interface.

4. The system of claim 1 wherein the logic is further configured to report the feedback with the result of the query.

5. The system of claim 1 wherein the logic is further configured to assign a weight to the feedback based on attributes of the at least one user.

6. The system of claim 1 wherein the logic is further configured to enhance the result based on the source of the result.

7. The system of claim 1 wherein the plurality of data sources are integrated into a single data repository.

8. The system of claim 1 wherein the feedback is selected from the group consisting of a rating, a ranking, and a review.

9. A method, comprising:
receiving information from a user describing the quality of search results;
storing the information in a data repository; and
improving future search results based on the information.

10. The method of claim 9 wherein improving comprises prioritizing the future search results based on relevancy.

11. The method of claim 9 wherein improving comprises removing irrelevant items from the future search results.

12. The method of claim 9 further comprising assigning an importance factor to the user and associating the importance factor to the information.

13. The method of claim 9 further comprising receiving feedback from a user that describes the information.

14. The method of claim 13 further comprising improving future search results based on the feedback.

15. A computer readable medium storing a program that, when executed by a processor of a computer, performs a method comprising:
receiving data from a user describing the quality of search results;
storing the data in a repository; and
improving subsequent search results based on the data.

16. The method of claim 15 wherein improving comprises prioritizing the subsequent search results based on relevancy.

17. The method of claim 15 wherein improving comprises removing irrelevant items from the subsequent search results.

18. The method of claim 15 further comprising assigning an importance factor to the user and associating the importance factor to the data.

19. The method of claim 15 further comprising receiving feedback from a user that describes the data.

20. The method of claim 19 further comprising improving subsequent search results based on the feedback.
